(19) United States
(12) Patent Application Publication
(10) Pub. No.: US 2012/0241044 A1
(43) Pub. Date: Sep. 27, 2012

(54) METHOD AND FILLING SYSTEM FOR FILLING CONTAINERS WITH A FILLING MATERIAL COMPOSED OF AT LEAST TWO COMPONENTS IN A VOLUME-AND/OR AMOUNT-CONTROLLED MANNER

(75) Inventors: Dieter-Rudolf Krulitsch, Bad Kreuznach (DE); Jonathan Lorenz, Bad Kreuznach (DE)

(73) Assignee: KHS GmbH, Dortmund (DE)

(21) Appl. No.: 13/513,882

(22) PCT Filed: Dec. 7, 2010
(86) PCT No.: PCT/EP2010/007409

§ 371 Date: Jun. 5, 2012

(30) Foreign Application Priority Data
Feb. 16, 2010 (DE) 10 2010 008 166.3

(51) Int. Cl. B67C 3/20; B67D 7/16; B67D 7/06

(52) U.S. Cl. 141/9; 141/100; 222/71

(57) ABSTRACT

A method for filling containers with a filling material having different components includes feeding a first component to a container to be filled, directly measuring an amount of the first component, carrying out one of an amount-controlled introduction of a second component into the container indirectly by measuring an amount flow rate of the first component resulting from an amount flow rate of the second component, wherein an amount flow rate of the second component is directly an amount flow rate flowing to a respective container, and an amount-measuring device used for the measurement is flowed through in the direction of flow during the direct measurement of the amount flow rate of the first component and the indirect measurement of the amount flow rate of the second component.

The invention relates to a method according to the preamble of patent claim 1 as well as to a filling system according to the preamble of patent claim 10.

Methods and filling systems are known for filling containers with a liquid filling material composed of at least two components which are introduced separately into the respective container in a volume-controlled and/or amount-controlled manner, in particular also for the bottling of fruit juices in which case one component for example liquid and homogenous [sic] and a further component exhibits for example a high proportion of solids, e.g. fruit pulp and/or fruit fibre.

Volume-measuring or amount-measuring devices or flowmeters, in particular contactlessly operating electronic flowmeters, for example magnetically inductive flowmeters, which may be very suitable for electrically conductive liquid and homogenous components and provide exact measurement signals depending on the particular volumetric flow rate but which are not or only partly suitable for non-homogenous components and in particular components containing a high concentration of solids, are often used for volume-controlled or amount-controlled filling.

For the volume-controlled or amount-controlled filling of a filling material composed of two components, it has already been proposed in our own but not yet published patent application DE 10 2009 049 583.5 that each of the components that are to be sequentially introduced into the respective container be provided with its own liquid path connected to a storage tank for the component concerned, and that a flowmeter be disposed in only one of the liquid paths, namely in the liquid path for a first liquid and homogenous component, said flowmeter directly measuring the amount of that component introduced into the respective container during filling and indirectly measuring the amount of a second component introduced into the respective container. This latter is achieved in that, before it is introduced into the container, the second component is passed into a part-length of the liquid channel of the first component and in the process the first component is displaced on this part-length and returns through the flowmeter into a tank holding the first component. This returning amount of the first component is measured with the flowmeter. The introduction of the second component into the tank does not take place directly while measuring, but in a further process step after measuring. There is a certain disadvantage in the fact that the components can mix together in the first liquid channel or in the part-length of said channel, and that, when being measured, the amounts of the first and second component flow through the flowmeter in opposite directions which can lead to measurement errors and/or necessitate a complex calibration of the flowmeter concerned.

The object of the invention is to propose a method which avoids the said disadvantages. A method according to patent claim 1 is configured to resolve this object. A filling system is the subject-matter of patent claim 10.

In the case of the invention, the amount or volume of the at least one second component is also measured indirectly by measuring or capturing the first component's volumetric flow rate which results from the volumetric flow rate of the at least one second component, the volumetric flow rate of the least one second component being the volumetric flow rate of this component directly flowing to the respective container. During direct and indirect measuring of the amount or volume of all components, the flow through the flowmeter used for the measurement is in one and the same direction, this also being the direction of flow in which the first component flows through the first liquid channel when introduced into the respective container. This is made possible by the fact that at least one first chamber is associated with the first liquid channel for the first component and at least one second chamber with variable volume is associated with the second liquid channel for the second component, and that when the second component is introduced into the respective container, the volume of the at least one second chamber associated with the second component is reduced, starting from an initial volume and accompanied by an increase in the volume of the at least one first chamber associated with the first component. As a result of this the first component flows through the flowmeter and on into the at least one first chamber. The amount (volume) of the first component measured by the flowmeter is equal to the amount (volume) of the second component introduced into the container. If the volume-controlled or amount-controlled introduction of several “second” components into each container is necessary, then the above described indirect measurement of the amounts (volumes) of the “second” components is carried out with a time delay.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

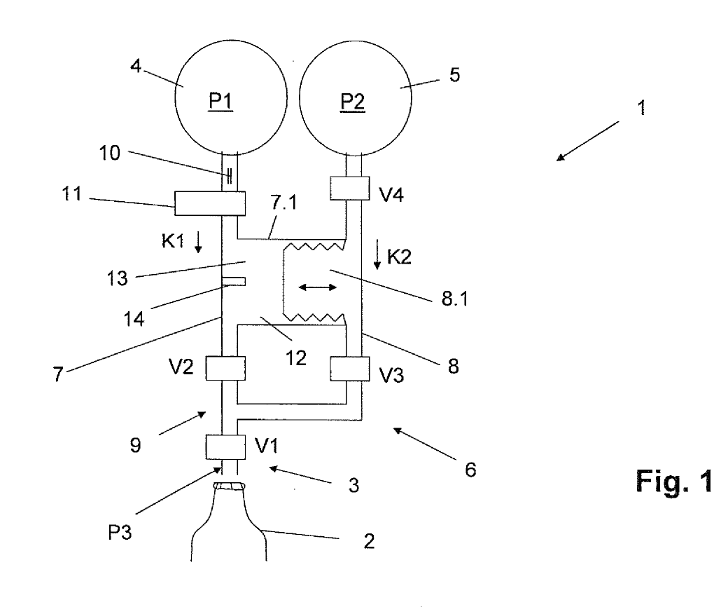

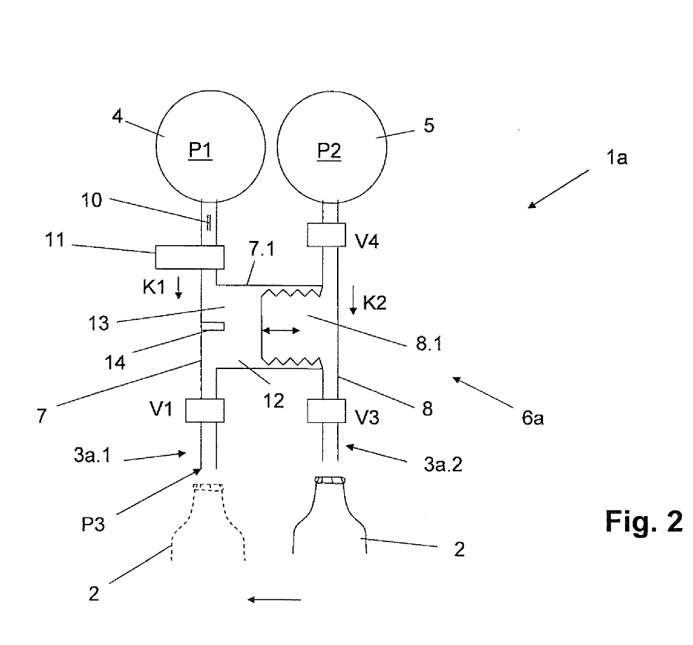

The invention is described below in greater detail by reference to FIGS. 1 and 2 which each schematically show a filling position of a filling systems for filling containers with two components K1 and K2 of a filling material.

FIG. 1 shows a schematic function representation of part of a filling system 1, for example of a rotary filling machine for filling containers 2 with the different components K1 and K2. During a filling process these components are introduced into the respective container 2 in an amount-controlled and/or volume-controlled manner in a given mix ratio or each with a given nominal volume, and also in such a way that each container 2 contains a given total amount of the mixed product, for example of a drink or fruit juice.

Component K1 is for example a liquid homogenous or essentially homogenous component, for example fruit juice. Component K2 is for example a non-homogenous component which with a reduced proportion of liquid contains a high proportion of solids, e.g. in the fruit pulp and/or fruit fibres etc.

Filling system 1 comprises a plurality of filling positions each with a filling element 3 which in the case of rotary filling machines is provided together with further filling elements on the periphery of a rotor driven to rotate about a vertical machine axis, in the manner known to the person skilled in the art. Filling element 3 is configured with a valve V1 (liquid valve) for the controlled starting and stopping of the filling process. During the filling process, the respective container 2 is disposed under filling element 3 or under a delivery opening there located, and in the depiction of FIG. 1 is at a distance away from filling element 3 for open jet filling. There are provided jointly for all filling elements 3 of the filling system two tanks 4 and 5 of which during the filling operation tank 4 contains component K1 with a pressure P1 and tank 5 contains component K2 with a pressure P2. At the delivery opening of filling element 3, components K1 and K2 flowing to container 2 exhibit the filling pressure P3 which in the case of open jet filling is equal to the ambient pressure. The pressure in tanks 4 and 5 is set so that pressure P1 is less than pressure P2 but greater than pressure P3, hence P3>P1>P2 [sic].

Filling element 3 is connected to both tanks 4 and 5 by a liquid connecting and proportioning structure which is generally indicated by 6 in FIG. 1. Within filling system 1 there is provided for each filling element 3 or for each filling position a separate liquid connecting and proportioning structure 6 each of which consists essentially of two liquid paths or liquid channels 7 and 8, of which liquid channel 7 is connected to tank 4 for component K1 and liquid channel 8 to tank 5 for component K2, and which in the direction of flow of components K1 and K2 flow at a mouth 9 into a common liquid channel of filling element 3, said channel being the continuation of liquid channel 7 in FIG. 1.

In liquid channel 7 there are provided sequentially in the direction of flow from tank 4 to liquid valve 3, a restrictor 10 for reducing the volumetric flow rate of component K1 when valves V1 and V2 are open, a flowmeter 11, for example in the form of a magnetically inductive flowmeter, and a valve V2. Liquid channel 7 is configured with an extension or first chamber 7.1 in the region between flowmeter 11 and valve V2.

A control valve V4 and a control valve V3 are provided sequentially in liquid channel 8 in the direction of flow from tank 5 to filling element 3 and/or to mouth 9. Between the two valves V4 and V3, liquid channel 8 is configured with an extension or second chamber 8.1 which in the depicted embodiment is formed by the interior space of a bellows 12 protruding into chamber 7.1. Bellows 12 or its movable and/or deformable walls separate the two chambers 7.1 and 8.1 in a fluid-tight or liquid-tight manner. Consequently chamber 8.1 possesses a variable volume to the extent that the volume of chamber 7.1 changes in inverse proportion to the volume of chamber 8.1.

It is self-evident that other embodiments of chambers whose volumes are inter-dependent in inverse proportion can also be used instead of bellows 12.

It is alternatively possible for example to provide a piston/cylinder arrangement which provides this function. For this, a cylinder with a preferentially overhung-mounted piston would have to be provided, with the piston being pressurised with the one component on the one side and with the other component on the other side. As a result of this arrangement the piston constitutes the separation or plane of separation between the two components, with the volumes of the two chambers 7.1 and 8.1 also being inter-dependent in inverse proportion. Because the piston is also easily displaceable through pressure differences between the two components, the chamber volumes can be easily adapted or altered in the desired manner.

Filling system 1 offers the advantage that with the aid of the only flowmeter 11, an amount-based and/or volume-based proportioning or introducing of components K1 and K2 into respective container 2 is possible, whereby during the measurement component K1 flows through flowmeter 11 in one direction of flow only, namely in the direction of flow from tank 4 to filling element 3. With the aid of flowmeter 11, the amount (volume) of component K1 fed to respective container 2 is measured directly and the amount (volume) of component K2 fed to respective container 2 is measured indirectly. The modus operandi of filling system 1 can be described as follows:

### 1.1. Initial State of Filling System 1

The valves in this phase of the filling process exhibit the following status:
V1: Closed
V2: Closed
V3: Closed
V4: Open

The two tanks 4 and 5 are filled with components K1 and K2 and pressurised with pressure P1 and P2. Bellows 12 lies with a base section 13 against a region of chamber 7.1 formed stop 14 [sic], so that chamber 8.1 exhibits its greatest volume (initial volume). Liquid channels 7 and 8 and their chambers 7.1 and 8.1 are completely filled with component K1 and K2 respectively.

### 1.2. Filling of Component K2 in Filling System 1

The valves in this phase of the filling process exhibit the following status:
V1: Open
V2: Closed
V3: Closed
V4: Open

Pressure P1 of component K1 in liquid channel 7 and in chamber 7.1 causes a compression of bellows 12 and hence an increasing reduction of the volume of chamber 8.1 as well as an introduction of component K2 via open valves V3 and V1 into container 2 standing ready under filling element 3. At the same time the volume in chamber 7.1 increases with the consequence of a volumetric flow rate of component K1 from tank 4 into chamber 7.1, with the amount (volume) measured by flowmeter 11 being equal to the amount of component K2 introduced from chamber 8.1 into container 2. Flowmeter 11 therefore supplies a measurement signal which corresponds to the amount (volume) of component K2 introduced into container 2 in this phase of the filling process.

The signal from flowmeter 11 stops this phase of the filling process in a controlled manner as soon as the required nominal volume of component K2 is introduced into container 2.

### 1.3. Filling of Component K1 in Filling System 1

The valves in this phase of the filling process exhibit the following status:
V1: Open
V2: Open
V3: Closed
V4: Open

Component K1 flows through open valves V1 and V2 into container 2 until the nominal volume for component K1 is reached. Monitoring is again effected by flowmeter 11. The measurement signal from flowmeter 11 closes valves V1 and V2 in a controlled manner when the nominal volume for component K1 is reached. The filling process is now complete. The filled container 2 can then removed from filling element 3 or from the filling position which exhibits this filling element.

### 1.4. Refilling Chamber 8.1 in Filling System 1

On completion of the filling process the liquid connection and proportioning section 6 is prepared for the filling of a further container 2. The status of the valves in this preparation phase is:
V1: Closed
V2: Closed
V3: Closed
V4: Open

The fact that pressure P2 is greater than pressure P1 causes component K2 to flow from tank 5 into chamber 8.1/bellows 12, so that eventually chamber 8.1 exhibits its maximum initial volume again and base section 13 lies against stop 14. The amount (volume) of component K1 which is displaced from chamber 7.1 flows through liquid channel 7 back to tank 4 without this amount (volume) being measured by flowmeter 11. The initial status is restored when the maximum initial volume of chamber 8.1 is reached, and the filling of the next container 2 can commence.

FIG. 2 shows as a further embodiment a filling system 1a which in essence only differs from filling system 1 in that the respective filling position exhibits two separate outlets or delivery openings for components K1 and K2, and wherein these outlets are formed either, as indicated in FIG. 2, by two independent filling elements 3a.1 and 3a.2 or by at least two separate delivery openings of one and the same filling element.

Accordingly liquid connecting and proportioning structure 6a which is again provided separately for each filling position of filling systems 1a differs from liquid connecting and proportioning structure 6 in that the two liquid channels 7 and 8 are not connected to one another but that instead liquid channel 7 is connected via valve V1 to the delivery opening of filling element 3a.1 and liquid channel 8 is connected via valve V3 to the delivery opening of filling element 3a.2. Valve V2 is not required.

The modus operandi of filling system 1a corresponds very broadly to that of filling system 1 and can be described as follows:

### 2.1. Initial State of Filling System 1a

The valves in this phase of the filling process exhibit the following status:

### V1: Closed

### V3: Closed

### V4: Open

The two tanks 4 and 5 are filled with components K1 and K2 and pressurised with pressure P1 and P2. Bellows 12 lies with a base section 13 against a region of chamber 7.1 formed stop 14 [sic], so that chamber 8.1 exhibits its greatest volume (initial volume). Liquid channels 7 and 8 and their chambers 7.1 and 8.1 are completely filled with component K1 and K2 respectively.

### 2.2. Filling of Component K2 in Filling System 1a

The valves in this phase of the filling process exhibit the following status:

### V1: Closed

### V3: Closed

### V4: Open

Here the respective container 2 is initially disposed beneath the delivery opening of filling element 3a.2.

Pressure P1 of component K1 in liquid channel 7 and in chamber 7.1 causes a compression of bellows 12 and hence an increasing reduction of the volume of chamber 8.1 as well as an introduction of component K2 via open valve V3 into container 2 standing ready under filling element 3a.2. At the same time the volume in chamber 7.1 increases with the consequence of a volumetric flow rate of component K1 from tank 4 into this chamber, with the amount (volume) measured by flowmeter 11 being equal to the amount of component K2 introduced from chamber 8.1 into container 2. Flowmeter 11 therefore supplies a measurement signal which corresponds to the amount (volume) of component K2 introduced into container 2 in this phase of the filling process.

The signal from flowmeter 11 stops this phase of the filling process in a controlled manner as soon as the required nominal volume of component K2 is introduced into container 2.

### 2.3. Filling of Component K1 in Filling System 1a

The valves in this phase of the filling process exhibit the following status:

### V1: Open

### V3: Closed

### V4: Open

To introduce component K1 into container 2, the latter is disposed beneath filling element 3a.1; this can be effected by appropriate movement of the respective container 2 and/or filling elements 3a.1 and 3a.2 of the filling position concerned.

Component K1 flows through open valve V1 into container 2 until the nominal volume for component K1 is reached. Monitoring is again effected by flowmeter 11. The measurement signal from flowmeter 11 closes valve V1 in a controlled manner when the nominal volume for component K1 is reached. The filling process is now complete. The filled container 2 can then be removed from filling element 3a.1 or from the filling position which exhibits this filling element.

### 2.4. Refilling Chamber 8.1 in Filling System 1a

On completion of the filling process the liquid connection and proportioning section 6a is prepared for the filling of a further container 2. The status of the valves in this preparation phase is:

### V1: Closed

### V3: Closed

### V4: Open

The fact that pressure P2 is greater than pressure P1 causes component K2 to flow from tank 5 into chamber 8.1/bellows 12, so that eventually chamber 8.1 exhibits its maximum initial volume again and base section 13 lies against stop 14. The amount (volume) of component K1 which is displaced from chamber 7.1 flows through liquid channel 7 back to tank 4 without this amount (volume) being measured by flowmeter 11. The initial status is restored when the maximum initial volume of chamber 8.1 is reached, and the filling of the next container 2 can commence.

The invention has been described hereinbefore by reference to embodiments. It goes without saying that variations as well as modifications are possible without departing from the inventive concept underlying the invention.

It is for example in particular possible to also realise chambers 7.1 and 8.1 with the variable volume by other means, for example generally by way of an enclosed space which is subdivided into chambers 7.1 and 8.1 by a movable wall or by at least one piston/cylinder arrangement having at least one piston axially displaceable in a cylinder and having two cylinder spaces which are separated from one another by, for example, this piston and of which one then forms chamber 7.1 and the other chamber 8.1.

It is also basically possible for liquid channel 8 with chamber 8.1, whose change of volume produces a corresponding volumetric flow rate in liquid channel 7 incorporating flowmeter 11, to be provided more than once so as to fill more than two components of a mixed product, for example of a mixed drink, into container 2 in an amount-controlled and/or volume-controlled manner while using a single flowmeter.

### LIST OF REFERENCE SIGNS

1, 1a Filling system
2 Container
3, 3a.1, 3a.2 Filling element
4,5 Tank
6, 6a Liquid connecting and proportioning structure
7,8 Liquid channel
7.1,8.1 Chamber
9 Mouth opening of liquid channel 8 into liquid channel 7
10 Restrictor
11 Flowmeter
12 Bellows
13 Base section
14 Stop
K1, K2 Component
P1, P2, P3 Pressure
V1-V4 Valve

1-16. (canceled)

16. A method for one of volume-controlled filling and amount-controlled filling of containers with a filling material comprising at least two different components, said method comprising feeding a first component to a container to be filled, directly measuring one of an amount of said first component and a volume of said first component, carrying out one of an amount-controlled introduction and a volume controlled introduction of at least one second component into said container indirectly by measuring one of an amount flow rate and a volumetric flow rate of said first component resulting from one of an amount flow rate and a volumetric flow rate of said at least one second component, wherein at least one of said one of an amount flow rate and a volumetric flow rate of said at least one second component is directly one of an amount flow rate and a volumetric flow rate flowing to a respective container, and one of an amount-measuring device and a volume-measuring device used for said measurement is flowed through in one and the same direction of flow during one of said direct measurement of the amount and the volume of the first component and the indirect measurement of one of the amount and the volume of the at least one second component.

17. The method of claim 16, wherein said amount measuring or volume measuring device comprises a flow meter.

18. The method of claim 16, further comprising using a filling system for one of the volume-controlled and the amount-controlled introduction of the first and of the at least one second component into the respective container, wherein the filling system comprises a first liquid channel for the first component having at least one first variable-volume chamber, and a separate second liquid channel for the at least one component having at least one second variable-volume chamber, wherein to generate the volumetric flow rate of the first component resulting from the volumetric flow rate of the at least one second component, the at least one second component is introduced from the at least one second chamber into the container, reducing the volume of said chamber, and wherein the reduction of the volume of the at least one second chamber brings about an increase in the volume of the at least one first chamber and hence a volumetric flow rate of the first component into the first chamber and through the amount-measuring or volume-measuring device.

19. The method of claim 18, wherein at least one first chamber is associated with a second chamber, and wherein the change of volume of the second chamber brings about an inverse change of volume of the assigned first chamber.

20. The method of claim 18, wherein at least one of the first chamber and the second chamber is formed by an interior space of a structure selected from the group consisting of a bellows, a bellows-like element, and a cylinder space of a piston/cylinder arrangement.

21. The method of claim 16, wherein the first and the at least one second component are introduced into the container through one of a common filling element, separate filling elements and separate delivery openings.

22. The method of claim 16, wherein the first component is pressurized by a first pressure, and wherein the change in volume of the at least one second component upon introduction thereof into said container is effected with at least the support of said first pressure exerted upon said first component.

23. The method of claim 16, said method further comprising, upon completion of said filling process, and in preparation for a subsequent filling process, feeding said second component under pressure to at least one second chamber as a volume of said second chamber increases to an initial volume thereof through displacement of said first component out of said first chamber.

24. The method of claim 16, further comprising before beginning a filling process, completely filling said second chamber and said second liquid channel with said second component, said second component being pressurized with a second pressure for filling said container, opening said second liquid channel for introducing said second component into said container at a third filling pressure that is lower than the second pressure, using one of the amount-measuring device and volume-measuring device, measuring a volumetric flow rate of said first component that results from a volumetric flow rate of said second component, upon reaching a nominal volume of said second component introduced into said container, closing said second liquid channel, opening said first liquid channel, and using one of the amount-measuring device and the volume-measuring device, introducing said first component into said container with the required nominal volume in a controlled manner.

25. The method of claim 24, wherein said first pressure is greater than said third pressure, and wherein said first pressure is less than said second pressure.

26. An apparatus for one of volume-controlled and amount-controlled filling of containers with a filling material composed of at least two different components, wherein a first component is fed to the first container to be filled through a first liquid channel, one of the amount of said first component and the volume of said first component being measured directly, and wherein one of volume-controlled introduction and amount-controlled introduction of at least one second component into the container is accomplished indirectly by measuring one of a volumetric flow rate and an amount flow rate of said first component resulting from one of a volumetric flow rate and an amount flow rate of said at least one second component, said apparatus comprising a filling system comprising a first variable-volume chamber provided in said first liquid channel for the first component and a second variable-volume chamber provided in a separate second liquid channel through which said at least one second component can be introduced into said container, said at least one first chamber being assigned to said second chamber, and wherein a change in volume of said second chamber brings about an inverse change of volume of an associated first chamber in such a way that one of a volumetric flow rate and an amount flow rate of said first component into said first chamber and through one of said amount-measuring device and said volume-measuring device is effected.

27. The apparatus of claim 26, wherein said filling system further comprises a structure having an interior space for forming at least one of said first chamber and said second chamber, said structure being selected from the group consisting of a bellows, a bellows-like element, and a cylinder space of a piston/cylinder arrangement.

28. The apparatus of claim 26, wherein said filling system comprises a filling structure selected from the group consisting of a common filling element, separate filling elements, and separate delivery openings for said components at each filling position.

29. The apparatus of claim 28, wherein said filling structure comprises separate delivery openings, and wherein said filling system further comprises a separate controllable valve provided in a liquid channel of each component before a delivery opening.

30. The apparatus of claim 26, wherein said filling system comprises one of an amount-measuring device and a volume-measuring device provided in said first liquid channel before said at least one first chamber in a direction of flow of said first component.

31. The apparatus of claim 26, wherein a chamber selected from the group consisting of said at least one first chamber and said at least one second chamber is formed by one of a section of at least one of said first liquid channel and said second liquid channel and an extension of at least one of said first liquid channel and said second liquid channel.

32. The apparatus of claim 26, wherein said filling system further comprises a separate controllable third valve in the second liquid channel before the at least one second chamber in the direction of flow of the second component.

33. The apparatus of claim 26, wherein said first liquid channel and said at least one second liquid channel are each connected to a source carrying one of said first component under a first pressure and said second component under a second pressure, and wherein said first pressure is greater than a filling pressure, and wherein said first pressure is less than said second pressure.

34. The apparatus of claim 33, wherein said source comprises a tank.
